(19) United States
(12) Patent Application Publication
(10) Pub. No.: US 2011/0002791 A1
(43) Pub. Date: Jan. 6, 2011

(54) Pump System for Removing Water from Pool Covers and Sumps

(75) Inventors: Humberto Valenzuela Meza, Tustin, CA (US); Jeffrey Brian Schopperle, Wakefield, MA (US); Jesus Estrada, Chihuahua (MX)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: ITT MANUFACTURING ENTERPRISES, INC., Wilmington, DE (US)

(21) Appl. No.: 12/755,766

(22) Filed: Apr. 7, 2010

Related U.S. Application Data
(60) Provisional application No. 61/167,307, filed on Apr. 7, 2009.

(51) Int. Cl. F04B 49/00; G05D 9/12

(52) U.S. Cl. 417/14; 137/1

(57) ABSTRACT

A pump system or device is provided for removing water from a pool cover or sump, featuring a controller configured to respond to a signal containing information about the ambient temperature in relation to a pump and to provide a controller signal containing information to control the operation of the pump based at least partly on the ambient temperature. The pumping system or device me be configured to include some combination of the following: temperature sensing, including a Thermistor, to change control logic at temperatures below a specific level (e.g. below 35 degrees F.); the initiation of impeller cycling at low operating temperatures to avoid ice formation in the impeller cavity and/or hose, but not for level sensing; the use of temperature feedback to turn off pump at low temperatures that may result in damage to the system; the addition of control logic to ignore torque increases due to contamination or flow-back Inclusion of soft-start of motor to reduce stress on impeller/motor; the option to connect Garden-style hose with an integral heating element to avoid freezing; a heating element to receive power from the pump via, e.g., a plug connector, where power to the heating element is supplied only when the temperature device is activated at some specified setting; the addition of a temperature sensor to render the pump inoperative if the temperature should fall below a set point (freezing); and/or the use of a field effect level sensor, such that the temperature sensing is substantially independent of the level of sensing device.

### CROSS-REFERENCE TO RELATED APPLICATIONS

This application claims benefit to patent application Ser. No. 61/167,307, filed 7 Apr. 2009, which is hereby incorporated by reference in its entirety.

### BACKGROUND OF THE INVENTION

1. Field of the Invention

The present invention relates to a method and apparatus for removing water from pool covers and sumps; and more particularly relates to an improved pump system for removing water from pool covers and sumps.

2. Brief Description of Related Art Techniques for removing water from pool covers and sumps are known in the art. For example, electric pumps have long been used for automatically removing water from the tops of pool covers. These systems have often relied on float-type switches for level sensing. Pool industry regulation requires that pool cover pump systems continue to operate when ambient temperatures drop to near or below the freezing point of water. (In other words, a pump must be able to remove water, regardless of temperature, while the cover is in place.) This requirement may ultimately rule out the use of floatswitch-controlled pumps.

Cold-weather performance also provides a benefit in the sump pump market. Anti-freeze features would be desirable in northerly climates and vacation homes with poorly controlled indoor temperatures during the off-season.

One known device does not require a float to sense water level, but rather uses motor torque sensing, or pumping force, to infer the presence of water. Periodic cycling of the impeller (e.g. 5 seconds every 2.5 minutes) provides a dual purpose of searching for water, and of delaying the freezing of water near the pump or in the outlet hose. However, this industry-standard design has been shown to be problematic when the inlet becomes contaminated with leaves, silt, etc. Certain applications also include long hoses on the outlet that can induce unwanted cycling due to flow-back when the pump turns off.

In view of this, there is a need in the industry for an improved pump to solve these problems in the art.

### SUMMARY OF THE INVENTION

The present invention provides a pumping system or device with a controller or control means for sensing fluid level in a variety of weather conditions.

For example, the pumping system or device may take the form of a pump having circuitry in the form of a controller or one or more controller modules configured to respond to a signal containing information the ambient temperature in relation to the pump system or device and to provide a controller signal containing information to control the operation of the pump system or device, including pumping water from a pool cover or sump, based at least partly on the ambient temperature.

The innovation may be used alone or together with one or more of the following:

The initiation of impeller cycling at low operating temperatures to avoid ice formation in impeller cavity and/or hose, but not for level sensing.

The use of temperature feedback to turn off pump at very low temperatures that may result in damage to the system.

The inclusion of temperature sensing by using a Thermistor to change control logic at temperatures below a specific level (e.g. 35 degrees F.).

The addition of a non-contacting level-sensing device to supplement existing torque-sensing control system.

The use of a non-contacting level-sensing device to replace the existing torque-sensing control system.

The addition of control logic to ignore torque increases due to contamination or flow-back

The controller may be configured with the inclusion of a soft-start of motor to reduce stress on impeller/motor.

The option to connect a garden-style hose with an integral heating element to avoid freezing in low temperatures.

A heating element may receive power from the pump via a plug connector.

The power to the heating element may be supplied only when the temperature device is activated at the specified setting.

Some embodiments of the present invention feature the addition of a temperature sensor to render the pump inoperative if the temperature should fall below a set point (freezing). While other embodiments may be used with a field effect level sensor, the temperature sensing is substantially independent of the level sensing device.

The method may also include steps for implementing the same consistent with that shown and described herein for removing water from pool covers and sumps, including arranging a pump on a pool cover or in sump; receiving in the one or more controller modules of the pump the signal containing information the ambient temperature in relation to a pump; and providing the controller signal containing information to control the operation of the pump, including pumping the water, based at least partly on the ambient temperature.

The invention described herein uses an enhanced fluid level sensing technique to overcome the weaknesses in the known prior art device, while meeting all current industry standards.

### BRIEF DESCRIPTION OF THE DRAWING

The drawing includes the following Figures:

FIG. 1 is a diagram of a pumping system showing an implementation according to some embodiments of the present invention.

FIG. 2 is a diagram of an illustration of the pumping system according to some embodiments of the present invention.

FIG. 3 is a sketch of the pumping system for implementing some embodiments of the present invention.

FIG. 4 is a sketch of a garden-style hose having an integral heating element according to some embodiments of the present invention.

### DETAILED DESCRIPTION OF THE INVENTION

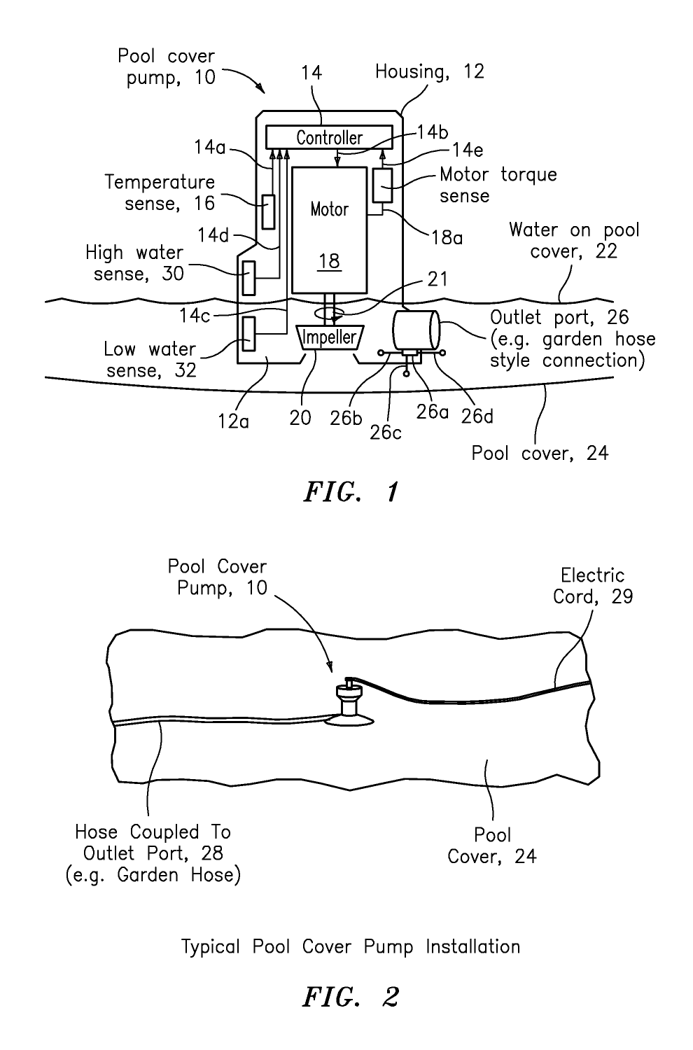

FIG. 1 shows, by way of example, a new pump system in the form of a pool cover pump generally indicated as 10 for removing water from a pool cover 24 or sump according to some embodiments of the present invention. The pool cover pump 10 includes a housing 12 configured to contain components. modules and circuitry for implementing the present invention.

For example, the pool cover pump 10 may include circuitry taking the form of a controller or one or more controller modules 14 configured to respond to a signal along line 14a containing information about the ambient temperature in relation to the pump 10 and to provide a controller signal along line 14b containing information to control the operation of the pump 10, including pumping water from the pool cover or sump, based at least partly on the signal containing information about the ambient temperature.

As shown, the signal along line 14a is received from a temperature sense or sensor 16 arranged in relation to the housing 12, while the controller signal along line 14b is provided to a motor 18 also arranged in relation to the housing 12. The temperature sense or sensor 16 may take the form of a thermistor, although the scope of the invention is intended to include other types or kinds of temperature sensing devices either now known or later developed in the future. Motors like 18 are known in the art, and the scope of the invention is intended to any particular type or kind either now known or later developed in the future.

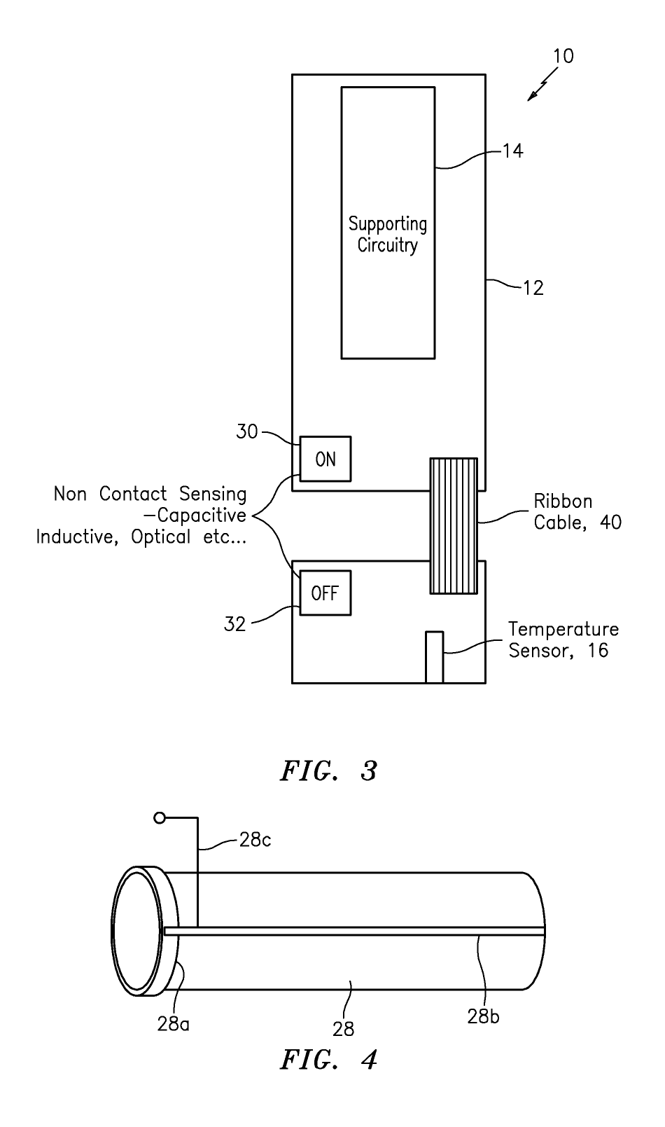

In operation, the motor 18 may be turned on to rotate an impeller 20 arranged on a shaft 21 for removing water 22 from the pool cover 24 or sump. The water 22 is removed from an impeller cavity 12a by pumping it out an outlet port 26 that is coupled to a hose 28 as shown in FIG. 2. The outlet port 26 may take the form of a garden hose style connection to which a garden hose 28 (FIGS. 2 and 4) may quickly and easily be coupled.

Alternatively, the controller or one or more controller modules 14 may be configured to turn off the motor 18 of the pump 10, e.g., at a very low preset temperature, including a low operating temperature of about 35° F.

The controller or one or more controller modules 14 may also be configured with control logic that changes at temperatures sensed below a predetermined temperature, e.g. freezing. For example, the controller or one or more controller modules may be configured to cycle the motor 18 and the impeller 20 at a low operating temperature to avoid ice formation in the impeller cavity 12a of the pump 10.

The pool cover pump 10 may also include non-contact level-sensors or sensing devices 30, 32, including a high water sense 30 and a low water sense 32. Non-contact level-sensors or sensing device like elements 30, 32 are known in the art and may take the form of capacitive, inductive or optical non-contact level-sensors or sensing device either now known or later developed in the future. By way of example, as shown in FIG. 3 the non-contact level-sensors or sensing devices 30, 32 may take the form of one water detection sensor 32 that responses to the level of the water 22 on the pool cover 24, and provides a signal along line 14c that is received by the controller 14, which turns the pump off when the water is at a lower level, as well as one water detection sensor 30 that responses to the level of the water 22 on the pool cover 24, and provides a signal along line 14d that is received by the controller 14, which turns the pump on when the water is at a higher level. As also shown in FIG. 3, the circuitry and components may be coupled together using a ribbon cable 40, although the scope of the invention is not intended to be limited to the manner in which the components. modules and circuitry for implementing the present invention are coupled together.

Furthermore, the scope of the invention is intended to include embodiments in which the controller or one or more controller modules 14 is configured to replace the non-contacting level-sensing device 30, 32; or in which the controller or one or more controller modules 14 is configured to supplement the non-contacting level-sensing device 30, 32, or in which the non-contacting level-sensing device 30, 32 is configured to supplement the controller or one or more controller modules 14; or some combination thereof.

The pool cover pump 10 is also configured with a motor torque sense 42 that receives a signal along line 18a from the motor 18, and provides a signal along line 14e containing information about the motor torque. In operation, the controller or one or more controller modules 14 may be configured to response to the signal along line 14e, and operate the motor 18 by providing signaling along line 14b based at least partly on the same, including to ignore torque increases, including those due to contamination or back-flow.

Moreover, the controller or one or more controller modules 14 may be configured to response to the signal along line 14e, and operate the motor 18 based at least partly on the same, by turning the motor on, by turning the motor off, by adjusting the speed of the motor, by adjusting the pulsing of the motor, or some combination thereof.

Embodiments of the present invention are also envisioned in which the controller or one or more controller modules 14 is configured to provide signaling along line 14b to soft start the motor 18 of the pump 10 to reduce stress on the motor/impeller 18, 20.

In operation, the controller or one or more control modules 14 may be used in the pumping device 10 along with pre-existing control means for sensing fluid level in a variety of weather conditions, as well as a non-contacting level-sensing device to supplement or replace existing torque-sensing control system 18.

The outlet port 26 may also be configured to be coupled to a corresponding garden-style connector 28a of the garden-style hose 28 shown in FIGS. 2 and 4. The garden-style hose 28 is configured with an integral heating element module 28b to avoid water freezing in the garden-style hose. In operation, the pump 10 is configured with a plug connector module and controller 26a configured to receive a control signal along line 26b, e.g., from the controller or one or more modules 14, and is also configured to receive power, e.g. from an electrical power cord 29 (FIG. 2) via along a line 26c. When the ambient temperature is below a predetermined temperature, or only when the temperature sense, sensor or device 16 is activated or sensed at some specified setting, the plug connector module and controller 26a is activated to provide a signal along line 26d to a corresponding line 28c forming part of the integral heating element 28b of the garden-style hose 28 (FIGS. 3 and 4) to generate heat to avoid water freezing in the garden-style hose 28. By way of example, the integral heating element module 28b of the garden-style hose 28 may take the form of a resistive based heating system to keep the water in the hose 28 from freezing.

### Implementations of the Functionality of the Controller or Control Module 14

The scope of the invention is not intended to be limited to the specific implementation of the controller or control module 14 shown in FIGS. 1 and 3. For example, embodiments are envisioned in which other circuit arrangements using other circuit components either now known or later developed in the future that may be used to achieve the desired functionality.

Further, consistent with that described herein, the functionality of the controller or control module may be implemented using other configurations of hardware, software, firmware, or a combination thereof, although the scope of the invention is not intended to be limited to any particular embodiment thereof. In a typical software implementation, the controller or control module 14 may include one or more microprocessor-based architectures having a microprocessor or microcontroller, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the control module being a stand alone module, as shown, or in the combination with other circuitry for implementing another module.

### THE SCOPE OF THE INVENTION

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

What we claim is:

1. A pump system or device for removing water from a pool cover or sump, comprising:
one or more controller modules configured to respond to a signal containing information about the ambient temperature in relation to the pump system or device and to provide a controller signal containing information to control the operation of the pump system or device, including pumping water from the pool cover or sump, based at least partly on the signal containing information about the ambient temperature.

2. A pump system or device according to claim 1, wherein the one or more controller modules is configured to cycle an impeller of the pump at a low operating temperature to avoid substantially ice formation in an impeller cavity of the pump system or device.

3. A pump system or device according to claim 1, wherein the pump system or device comprises one or more temperature sensing modules configured to sense the ambient temperature and provide the signal containing information about the same.

4. A pump system or device according to claim 3, wherein the one or more temperature sensing modules is a thermistor.

5. A pump system or device according to claim 2, wherein the low operating temperature is below 35° F.

6. A pump system or device according to claim 1, wherein the pump system or device comprises a non-contacting level-sensing device configured to sense the water level in the pool cover or sump, and provide signaling to the one or more controller modules.

7. A pump system or device according to claim 6, wherein the one or more controller modules is configured to supplement the operation of the non-contacting level-sensing device, including disabling the operation of the pump system or device when the ambient temperature falls below some specified temperature setting.

8. A pump system or device according to claim 1, wherein the one or more controller modules is configured to turn off the pump when the ambient temperature is below some specified temperature setting.

9. A pump system or device according to claim 1, wherein the one or more controller modules is configured to ignore some motor torque increases, including those due to contamination or back-flow.

10. A pump system or device according to claim 1, wherein the one or more controller modules is configured to provide signaling to soft start a motor of the pump to reduce stress on an impeller/motor of the pump system or device.

11. A pump system or device according to claim 1, wherein the one or more controller modules is configured with control logic that changes the operation of a pumping device at temperatures below a predetermined temperature.

12. A pump system or device according to claim 1, wherein the pump system or device comprises a garden-style hose having an integral heating element module that is configured to receive power and heat the garden-style hose to avoid water freezing therein.

13. A pump system or device according to claim 12, wherein the pump system or device comprises a plug connector and controller module configured to receive signaling from the one or more control modules, to receive the power, and also to provide the power to the integral heating element module of the garden-style hose based at least partly on the ambient temperature.

14. A method for removing water from a pool cover or sump, comprising:
arranging a pump on a pool cover or in a sump;
receiving in one or more controller modules of the pump a signal containing information about the ambient temperature in relation to the pump; and
providing a controller signal containing information to control the operation of the pump, including pumping water from the pool cover or the sump, based at least partly on the signal containing information about the ambient temperature.

15. A method according to claim 14, wherein the method comprises cycling with the one or more controller modules an impeller of the pump at a low operating temperature to avoid ice formation in an impeller cavity of the pump.

16. A method according to claim 14, wherein the method comprises sensing with one or more temperature sensing modules the ambient temperature and providing the signal containing information about the same to the one or more controller modules.

17. A method according to claim 16, wherein the method comprises sensing with the ambient temperature with a thermistor.

18. A method according to claim 15, wherein the low operating temperature is below 35° F.

19. A method according to claim 14, wherein the method comprises turning off the pump with the one or more controller modules when the ambient temperature is below a very low temperature. including below a freezing temperature.
